(19) United States
(12) Patent Application Publication
(10) Pub. No.: US 2009/0205372 A1
(43) Pub. Date: Aug. 20, 2009

(54) METHOD AND DEVICE FOR FORMING HOLE IN GLASS SUBSTRATE

(75) Inventor: Kiyoshi Takekoshi, Yamanashi (JP)

Correspondence Address: PEARNE & GORDON LLP, 1801 EAST 9TH STREET, SUITE 1200, CLEVELAND, OH, 44114-3108, US

(73) Assignee: TOYKO ELECTRON LIMITED, Toyko (JP)

(21) Appl. No.: 11/995,177

(22) PCT Filed: Jul. 12, 2006
(86) PCT No.: PCT/JP2006/313842

§ 371 Date: Jan. 15, 2008

(30) Foreign Application Priority Data
Jul. 13, 2005 (JP) 2005-204003

(51) Int. Cl. C03C 19/00; C03B 23/00; C03B 23/26

(52) U.S. Cl. 65/61; 65/85; 65/166; 65/157

(57) ABSTRACT

A large number of fine and deep holes are fanned in a glass substrate with high positional and dimensional accuracy.

With a use of an etching of a photolithography technique, a large number of fine holes are formed in a silicon substrate. Hole forming pins are stood in the holes. The silicon substrate is held by a holding member of a hole forming apparatus. The glass substrate is housed in a container having an opened upper surface. The container is heated, and the glass substrate housed in the container is melted. The silicon substrate is lowered using the holding member, and the hole forming pins are inserted into the glass substrate. Thereafter, the container is cooled, and the glass substrate is solidified while having the hole forming pins inserted therein. The glass substrate is taken out from the container, the hole forming pins are dissolved in an aqua regia to thereby form the holes in the glass substrate.

### TECHNICAL FIELD

The present invention relates to a method of Conning holes in a glass substrate and a hole forming apparatus.

### BACKGROUND ART

A borosilicate glass substrate represented by Pyrex (registered trademark of the Corning Company), for example, is used for manufacturing an electronic device suck as a pressure sensor, a speed sensor and the like, and a nozzle for applying as adhesive. In this case, there is a need to form fine holes in a glass substrate. Conventionally, as a process for forming holes in the glass substrate, machining such as a drilling process, an ultrasonic process, a blast process or the like, and a laser process have been mainly adopted (refer to Patent Documents 1 and 2).

### [Patent Document 1]

Japanese Patent Application Laid-open No. 2000-343308

### [Patent Document 2]

Japanese Patent Application Laid-open No. Hei 11-186678

### DISCLOSURE OF THE INVENTION

### Problems to be Solved by the Invention

However, along with the improvement of performance and miniaturization of products using a glass substrate such as a pressure sensor, there has been brought a demand for forming several thousand fine holes in the glass substrate at a level of micron order, in which a high level of positional and dimensional accuracy is further required for each hole. Further, regarding the shape of the holes, it is needed to form deep holes having a depth of 1 mm or more with various shapes. In a conventional processing method, such a large number of fine holes at a level of micron order could not be formed with high positional and dimensional accuracy with a depth of 0.5 mm or more, and it was impossible to flexibly deal with the demand for various shapes of the holes.

The present invention has been developed in consideration of the above points and an object thereof is to form a large number of fine and deep holes in the glass substrate with high positional and dimensional accuracy, and further to form the holes of various shapes.

### Means for Solving the Problems

The present invention to achieve die above object is a method of forming holes in a glass substrate, and the method has the steps of: housing the glass substrate in a container having an opened upper surface; forming a plurality of holes in a pin stand substrate and standing pins in the plurality of holes formed in the pin stand substrate; placing the pin stand substrate opposite the glass substrate so that the pins of the pin stand substrate face a side of the glass substrate housed in the container; heating and melting the glass substrate housed in the container, approximating the pin stand substrate to the melted glass substrate and inserting the pins of the pin stand substrate into the glass substrate; cooling and solidifying the glass substrate housed in the container while having the pins inserted therein; taking out the glass substrate from the container; and forming holes in the glass substrate by removing the pins inserted therein. Note that the pin stand substrate is a substrate for standing pins.

According to the present invention, a large number of fine holes possessing high positional and dimensional accuracy are formed in the pin stand substrate, and holes can be formed in the glass substrate by the pins standing in the plurality of holes. Accordingly, it becomes possible to form the large number of fine holes in the glass substrate with high positional and dimensional accuracy. Further, the shape of the holes can be changed easily according to the shape of the pins, so that deep holes having a depth of 1 mm or more or various shapes of holes can be formed, for example. Note that in the method of forming the holes in the glass substrate described above, an etching can be adopted to form the plurality of holes in the pin stand substrate.

The method of forming the holes in the glass substrate may further have a step of penetrating the holes of the glass substrate by polishing a lower surface of the glass substrate after the pins are removed therefrom.

The step of inserting the pins into the glass substrate may be performed by lowering the glass substrate in a predetermined speed using a raisable/lowerable holding member holding the glass substrate.

When the glass substrate housed in the container is heated, the pin stand substrate may also be heated together. Further, the pin stand substrate may be a silicon substrate. The container may be made of carbon.

The pin may be made of a material possessing a heat resistance to a heating temperature of the glass substrate. Further, the pin may be dissolved by liquid to be removed from the glass substrate. The pin may be made of metal and dissolved in an aqua regia. Further, the pin may be formed of tungsten, stainless steel, molybdenum, nickel or nickel alloy.

At least the steps of melting the glass substrate, inserting the pins into the glass substrate, and solidifying the glass substrate may be carried out in a reduced oxygen atmosphere. Further, the reduced oxygen atmosphere may be a reduced pressure atmosphere.

The present invention according to another aspect proposes a hole forming apparatus for forming holes in a glass substrate, and the hole forming apparatus has: a container having an opened upper surface and capable of housing the glass substrate; a heating container housing and heating the container; a holding member holding a pin stand substrate having pins stood thereon above the container so that the pins face a side of the glass substrate housed in the container; and a raising/lowering mechanism for inserting the pins of the pin stand substrate into the glass substrate housed in the container by raising/lowering the holding member.

The holding member may be provided with a heating member for heating the held pin stand substrate. Further, the container may be made of carbon.

The hole forming apparatus may have a mechanism for maintaining the inside of the heating container to be a reduced oxygen atmosphere. Further, the mechanism for maintaining the reduced oxygen atmosphere may be a pressure reducing mechanism.

### Effect of the Invention

According to the present invention, it is possible to form a large number of fine and deep holes in a glass substrate with high positional and dimensional accuracy, and further to form various shapes of holes.

### BRIEF DESCRIPTION OF THE DRAWINGS

[FIG. 1]

A longitudinal sectional view showing a schematic configuration of a hole forming apparatus.

[FIG. 2]

A perspective view of a holding member.

[FIG. 3]

A perspective view of a silicon substrate.

[FIG. 4]

A longitudinal sectional view of the silicon substrate having hole forming pins feed thereto.

[FIGS. 5(a) to 5(d)]

FIG. 5(a) shows a state in which the silicon substrate and a glass substrate are placed close to each other. FIG. 5(b) shows a state in which the glass substrate is melted. FIG. 5(c) shows a state in which the hole forming pins of the silicon substrate are inserted into the glass substrate. FIG. 5(d) shows a state in which the glass substrate is cooled and solidified.

[FIGS. 6(a) to 6(c)]

FIG. 6(a) shows a state in which the glass substrate is taken out from a heating container. FIG. 6(b) shows a state in which the hole forming pins of the glass substrate are melted. FIG. 6(c) shows a state m which a lower surface of me glass substrate is polished.

[FIG. 7]

A longitudinal sectional view of the hole forming apparatus equipped with a heater in the holding member.

[FIGS. 8(a) to 8(c)]

FIG. 8(a) shows a state in which the glass substrate haying the hole forming pins inserted therein is taken out from the heating container. FIG. 8(b) shows a state in which the hole forming pins of the glass substrate are melted. FIG. 8(c) shows a state in which the lower surface of the glass substrate is polished.

[FIGS. 9(a) to 9(c)]

FIG. 9(a) shows a state in which the glass substrate having the hole forming pins inserted therein is taken out from the heating container. FIG. 9(b) shows a slate in which the hole foaming pins of the gloss substrate are melted. FIG. 9(c) shows a state in which the lower surface of the glass substrate is polished.

[FIGS. 10(a) to 10(c)]

FIG. 10(a) shows a state in which holes each having a spherical-shaped tip are formed in the glass substrate. FIG. 10(b) shows a state in which holes each having a wide central portion are formed in the glass substrate. FIG. 10(c) shows a state in which holes each having a narrow central portion are formed in the glass substrate.

[FIG. 11]

A longitudinal sectional view of the silicon substrate where angled hole forming pins are stood thereon.

[FIGS. 12(a) to 12(c)]

FIG. 12(a) shows a state hi which the silicon substrate having the angled hole forming pins attached thereto is held by the holding member. FIG. 12(b) shows a state in which the hole forming pins are diagonally inserted into the glass substrate. FIG. 12(c) shows a state in which angled holes are formed in the glass substrate.

[FIG. 13]

A longitudinal sectional view showing a schematic configuration of a hole forming apparatus equipped with a pressure reducing mechanism.

### EXPLANATION OF CODES

1 hole forming apparatus

10 glass substrate

20 container

41 holding member

50 silicon substrate

50a hole

90 hole forming pin

### BEST MODE FOR CARRYING OUT THE INVENTION

Hereinafter, a preferred embodiment of the present invention will be described. FIG. 1 shows a schematic configuration of a hole forming apparatus 1 for conducting a method of forming holes in a glass substrate according to the present embodiment.

The hole forming apparatus 1 is provided with a container 20 housing a glass substrate 10. The container 20 is formed in a box-shape having an opened upper surface and a longitudinal section of a recessed shape. Side surfaces of the inside of the container 20 are formed in a tapered shape so that an inside diameter of the container 20 becomes gradually large from a bottom surface of the container 20 toward the opening surface thereof. The container 20 is made of a material which is not welded to the glass substrate 10, and having a linear expansion coefficient smaller than the glass substrate 10 with an excellent thermal conductivity, such as carbon. Accordingly, it can eliminate such possibilities that the glass substrate 10 housed in the container 20 is damaged due to a contraction at a time of cooling, or the glass substrate 10 cannot be taken out from the container 20 after the cooling.

The container 20 is housed in a heating container 31 while being supported by supporting members 30. The heating container 31 is formed, for example, in a substantially cylindrical shape having an opened upper surface and a closed bottom surface. The heating container 31 is made of, for example, a quartz glass. An upper surface opening portion of the heating container 31 is closed b an air-tight state with a lid body 32. The lid body 32 is made of, tor example, ceramics.

Heaters 33 generating heat when the power is supplied are placed in a periphery of the heating container 31. The heaters 33 are placed, for example, in lateral surfaces and a lower surface of the heating container 31.

The heating container 31 is covered by an outer cover 34 made of a heat insulating material. The heaters 33 are interposed between me outer cover 34 and the heating container 31.

A through hole 32a penetrating vertically is formed at a central portion of the lid body 32. A shaft 40 extending vertically from above the lid body 32 to me inside of the heating container 31 is inserted in the through hole 32a. The shaft 40 is made of, for example, ceramics. The shaft 40 is formed in a hollow shape, for instance.

A holding member 41 having, for example, a substantially disk shape is attached to a lower end portion of the shaft 40. A lower surface 41a of the holding member 41 is formed horizontally, as shown in FIG. 2. A suction port 41b is formed on the lower surface 41a of the holding member 41. The suction port 41b is connected to a negative pressure generating device such as a vacuum pump (not shown) via a vacuum line 42 passing through inside of the shaft 40, as shown in FIG. 1. A start/stop of the suction through the suction port 41b allows a silicon substrate 50 being a pin stand substrate to be attached to/detached from the lower surface 41a of the holding member 41.

An upper end portion of the shaft 40 is connected to a raising/lowering driving unit 70 such as a motor placed above the lid body 32. The raising/lowering driving unit 70 is supported on supporting plates 71 being placed, for example, on an upper surface of the lid body 32. An operation of the raising/lowering driving unit 70 is controlled by, for instances a control unit 72. The raising/lowering driving unit 70 vertically moves the shaft 40 to move the holding member 41 in a vertical direction, which enables the silicon substrate 50 held by the holding member 41 to be close to/apart from the glass substrate 10 housed in the container 20. A raising/lowering speed and a raised/lowered position of the silicon substrate 50 are controlled by the control unit 72. Note that in the present embodiment, the raising/lowering driving unit 70 and the control unit 72 compose a raising/lowering mechanism.

For example, a disk-shaped flange 80 is attached to the shaft 40 between the lid body 32 and the raising/lowering driving unit 70. Between the flange 80 and the lid body 32, expandable/contractable bellows 81 are interposed. The bellows 81 are provided with a not-illustrated cooling mechanism to control transmission of heat from a side of the heating container 31 to a side of the raising/lowering driving unit 70. Note that the vacuum line 42 is connected to the external negative pressure generating device via the flange 80.

The hole forming apparatus 1 is provided with a gas supply pipe 85 supplying a predetermined gas to the inside of the heating container 31. The gas supply pipe 85 is connected, for example, to a side surface of the heating container 31. The gas supply pipe 85 communicates with a gas supply source 86. In the present embodiment, the gas supply source 86 is charged with nitrogen gas, and the nitrogen gas is supplied to the inside of the heating container 31 through the gas supply pipe 85. Note that in the present embodiment, the gas supply pipe 85 and the gas supply source 86, for example, compose a mechanism which maintains the inside of the heating container 31 in a reduced oxygen atmosphere.

Next, a method of forming holes in the glass substrate 10 using the above-described hole forming apparatus 1 will be explained. In the present embodiment, a case where a large number of circular through holes are formed in the glass substrate 10 made of borosilicate glass such as Pyrex glass (registered trademark of the Corning Company) is explained as an example.

First, a plurality of circular holes 50a are formed at predetermined positions of the square-shaped silicon substrate 50, as shown in FIG. 3, and column-shaped hole forming pins 90 are respectively inserted in each of the holes 50a. The holes 50a of the silicon substrate 50 are formed by a dry etching process of a photolithography technique. The holes 50a are, for example, formed in a pitch distance of 100 μm or smaller with a diameter of about 50 μm and are provided with positional and dimensional accuracy within 2 μm. The hole 50a is formed in a diameter slightly larger than that of the hole forming pin 90 to be inserted therein. Positions and the number of the holes 50a of the silicon substrate 50 are appropriately set in accordance with positions of holes 100 to be ultimately formed in the glass substrate 10.

The hole forming pin 90 possesses a heat resistance to a temperature at, for example, later-described heating, which is 1000° C., for instance, and is made of metal such as tungsten, stainless steel, molybdenum, nickel or nickel alloy. The hole forming pin 90 is formed by cutting a metal wire, performing cutting using a lathe and the like, or using a plating technique such as a LIGA process. The hole forming pin 90 is, for example, formed in a length of 1 mm or more with a diameter of about 50 μm.

An adhesive L is applied to the silicon substrate 50 when the hole forming pins 90 are inserted therein, to thereby fix the hole forming pins 90 to the silicon substrate 50, as shown in FIG. 4. For the adhesive L, the one which can prevent the hole fanning pins 90 from coming off and falling even when, for example, being carbonized under high-temperature circumstances is adopted. Note that the fixing of the hole forming pins 90 can be performed by, for example, a press fitting.

The silicon substrate 50 having the hole forming pins 90 fixed thereto is sucked and held on a lower surface of the holding member 41 in the hole forming apparatus 1, in a state that the hole forming pins 90 are feeing downward, as shown in FIG. 1. The suction of the silicon substrate 50 is conducted by a suction through the suction port 41b.

Meanwhile, the glass substrate 10 being thin, square and flat shape is housed in the container 20 of the hole forming apparatus 1. When the glass substrate 10 is housed in the container 20, nitrogen gas is supplied to the inside of the heating container 31 through the gas supply pipe 85. Accordingly, the inside of the heating container 31 is maintained in a nitrogen atmosphere, that is, a reduced oxygen atmosphere. At this time, the inside of the heating container 31 is maintained in a positive pressure with respect to the outside, and the outside air is prevented from entering the inside of the heating container 31.

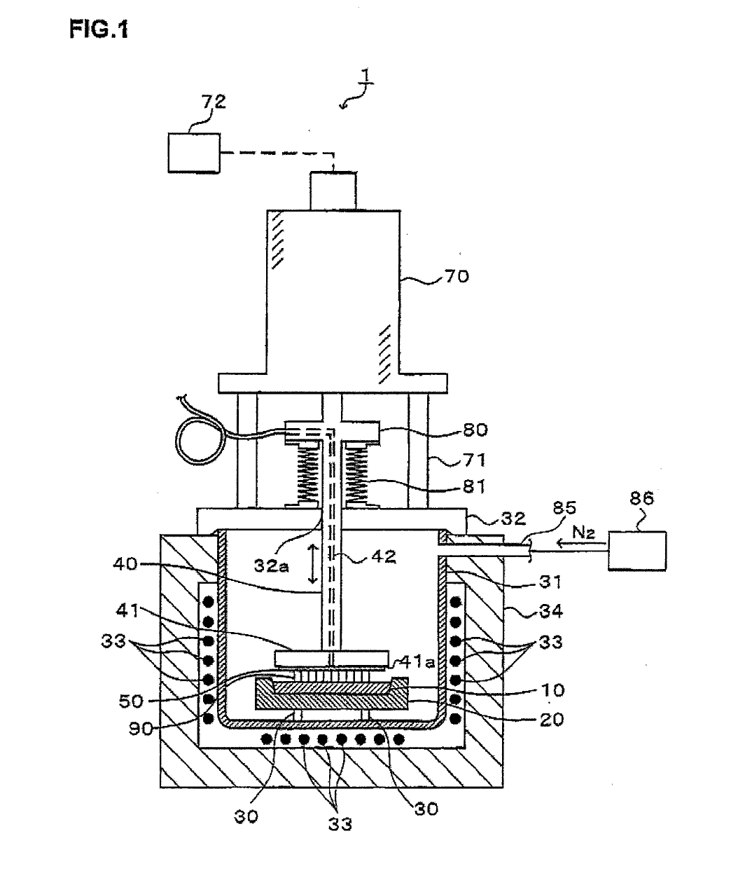

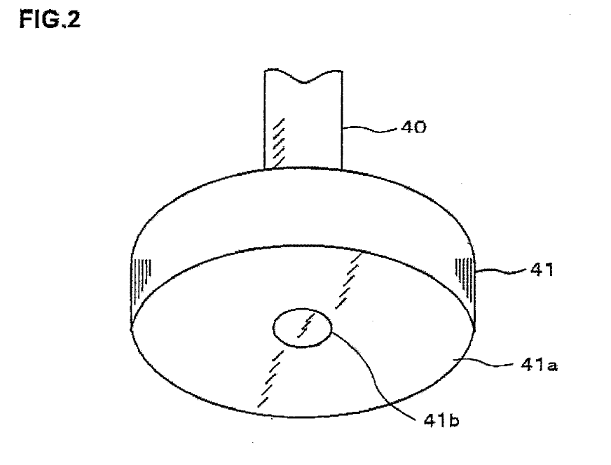

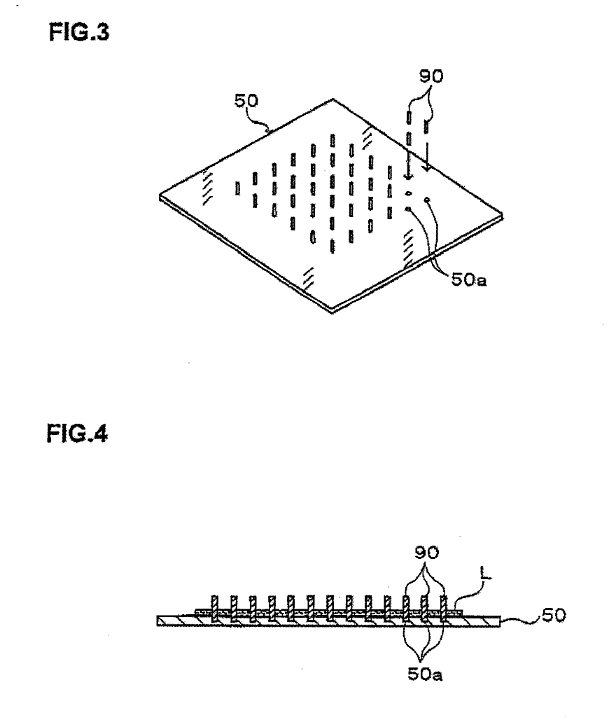

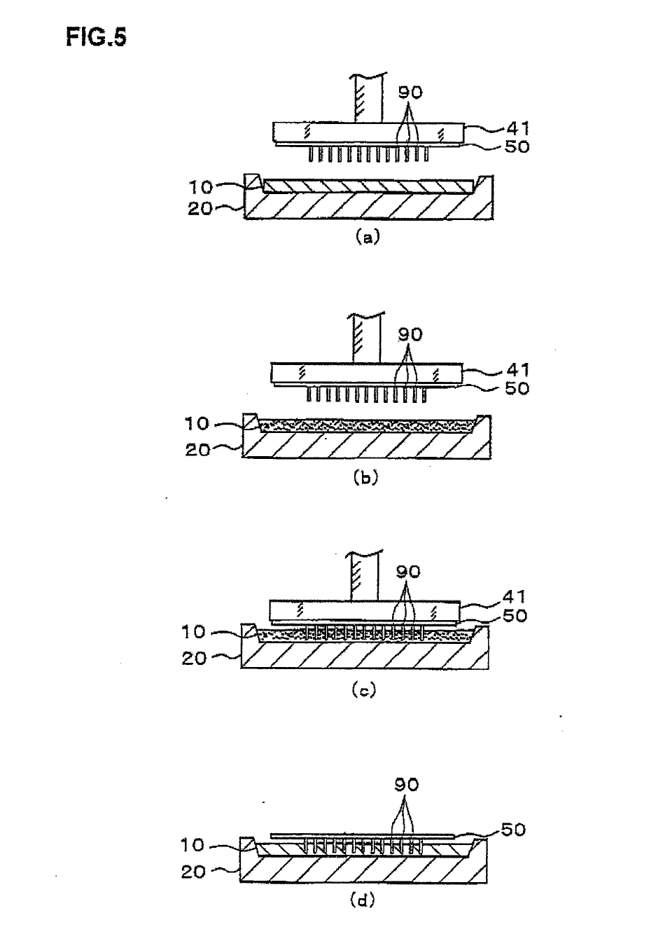

Next, the temperature of the inside of the heating container 31 is raised by the heat generated in the heaters 33, in a state that the silicon substrate 50 and the glass substrate 10 are approximated to each other, as shown in FIG. 5(a). Accordingly, the glass substrate 10 housed in the container 20 is heated to about 1000° C., which is higher than the softening temperature of the glass substrate 10. At this time, the silicon substrate 50 and the hole forming pins 90 are also heated at a temperature substantially the same as that of the glass substrate 10,

When the temperature of the glass substrate 10 is beyond its softening temperature, the glass substrate 10 starts melting (FIG. 5(b)). When the glass substrate 10 starts melting, the control unit 72 operates the raising/lowering driving unit 70 to lower the holding member 41 at a predetermined speed until it reaches a predetermined position (FIG. 5(c)), Accordingly, the hole forming pins 90 of the silicon substrate 50 are inserted into the glass substrate 10 at a predetermined depth. Thereafter, the heating by the heaters 33 is stopped, and the glass substrate 10 is cooled until the temperature reaches about 100° C. and solidified while having the hole foaming pins 90 inserted therein. The cooling is performed gradually compared to the temperature fluctuation at the time of heating. Further, the cooling is conducted while the silicon substrate 50 is being held by the holding member 41.

When the glass substrate 10 is cooled to be solidified, the suction by the holding member 41 through the suction port 41b is stopped, and the holding member 41 is raised by the raising/lowering driving unit 70 and is apart from the silicon substrate 50 (FIG. 5(d)).

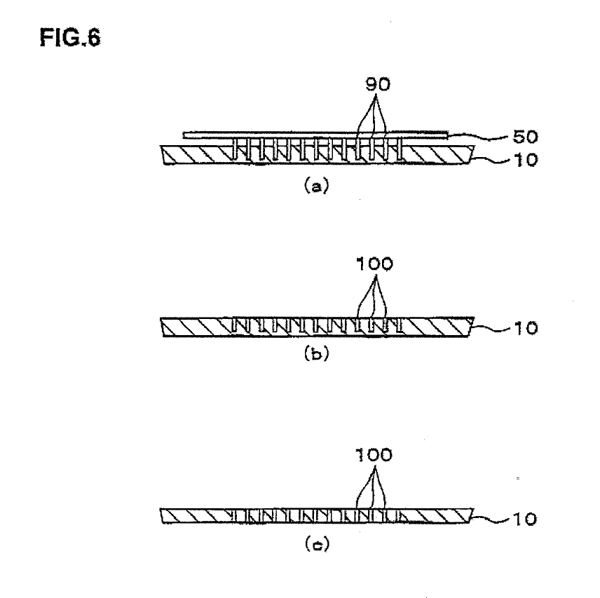

Next, the glass substrate 10 is taken out from the heating container 31 in a state of having the hole forming pins 90 and the silicon substrate 20 attached thereto, as shown in FIG. 6(a).

When the glass substrate 10 is taken out from the heating container 31, it is then immersed in liquid chemical such as, for example, an aqua regia to dissolve the hole forming pins 90 (FIG. 6(b)). Accordingly, the hole forming pins 90 and the silicon substrate 50 are removed from the glass substrate 10, thereby forming the holes 100 in an upper surface of the glass substrate 10.

Thereafter, a lower surface of the glass substrate 10 is polished, for example, to penetrate the holes 100 of the glass substrate 10. Accordingly, for example, the holes 100 each having a diameter of 50 μm and a depth of 1 mm or more are formed in the glass substrate 10 in a pitch distance of 100 μm or less (FIG. 6(c)). After that, the upper surface of the glass substrate 10 is polished, if required.

According to the above-described embodiment, the hole forming pins 90 are stood in the holes 50a of the silicon substrate 50 formed by the etching, the silicon substrate 50 is lowered by the holding member 41, the hole forming pins 90 are inserted into the melted glass substrate 10, to thereby form the holes 100 in the glass substrate 10. In such a case, a large number of fine holes 50a having high positional and dimensional accuracy are formed in the silicon substrate 50, and the holes 100 are formed in the glass substrate 10 by the hole forming pins 90 standing in the holes 50a. Therefore, if is possible to form a large number of fine holes 100 having high positional and dimensional accuracy. Further, depending on the dimension of the hole forming pins 90, deep holes 100 each having a depth of 1 mm or more can be formed in the glass substrate 10. Furthermore, by varying the shapes of the holes 50a and the hole forming pins 90, the holes 100 of various shapes can be easily formed in the glass substrate 10.

In the above-described embodiment, since the holding member 41 holding the silicon substrate 50 is vertically moved by the raising/lowering driving unit 70 controlled by the control unit 72, the hole forming pins 90 can be inserted into the glass substrate 10 in a predetermined speed and depth. Accordingly, it is possible to form the holes in the glass substrate 10 with higher dimensional accuracy.

Since the hole forming pins 90 are dissolved in the aqua regia when being removed from the glass substrate 10, comparing to a case where the hole forming pins 90 are pulled out to be removed, it is possible to properly remove even thinner hole forming pins 90. Accordingly, the finer holes 100 can be formed.

In the above-described embodiment, the silicon substrate 50 held by the holding member 41 is also heated at a temperature substantially the same as that of the glass substrate 10 by the heaters 33 of the heating container 31, and the hole forming pins 90 are men inserted into the glass substrate 10. Therefore, there is no risk of rapid thermal expansion of the silicon substrate 50 after the insertion of the hole forming pins 90, which will cause a positional displacement of the hole forming pins 90. For that reason, the positional accuracy of the holes 100 can be further improved.

The holding member 41 described in the above embodiment may have a heater 110 built therein, as a hearing member for heating the silicon substrate 50, as shown in FIG. 7. In this case, with the use of the heater 110, the temperature of the holding member 41 is controlled to be 100° C., which is the same as the heating temperature of the glass substrate 10, and the heated holding member 41 holds the silicon substrate 50. Accordingly, the temperature of the silicon substrate 50 is maintained at about 1000° C. Thereafter, when the glass substrate 10 starts melting, the holding member 41 is lowered and the hole forming pins 90 Of the silicon substrate 50 are inserted into the glass substrate 10. According to the example, the temperature of the silicon substrate 50 is controlled to be the heating temperature of the glass substrate 10, so that the silicon substrate 50 is thermally expanded before the insertion of the hole forming pins 90. Accordingly, there is no chance that the silicon substrate 50 is thermally expanded wheal it contacts with the high-temperatured glass substrate 10, which will cause a positional displacement of the hole forming pins 90. Therefore, with the use of the hole forming pins 90, the holes 100 with higher positional accuracy can be formed.

It is difficult to perfectly match the linear thermal expansion coefficients of the silicon substrate 50 and the glass substrate 10. Therefore, the holes 50a of the silicon substrate 50 may be formed in previous consideration of the linear thermal expansion coefficients of the silicon substrate 50 and the glass substrate 10. For example, a forming position and a dimension of the holes 50a are corrected based on the linear thermal expansion coefficient of the silicon substrate 50. Accordingly, the holes 100 with higher positional accuracy can be formed in the glass substrate 10.

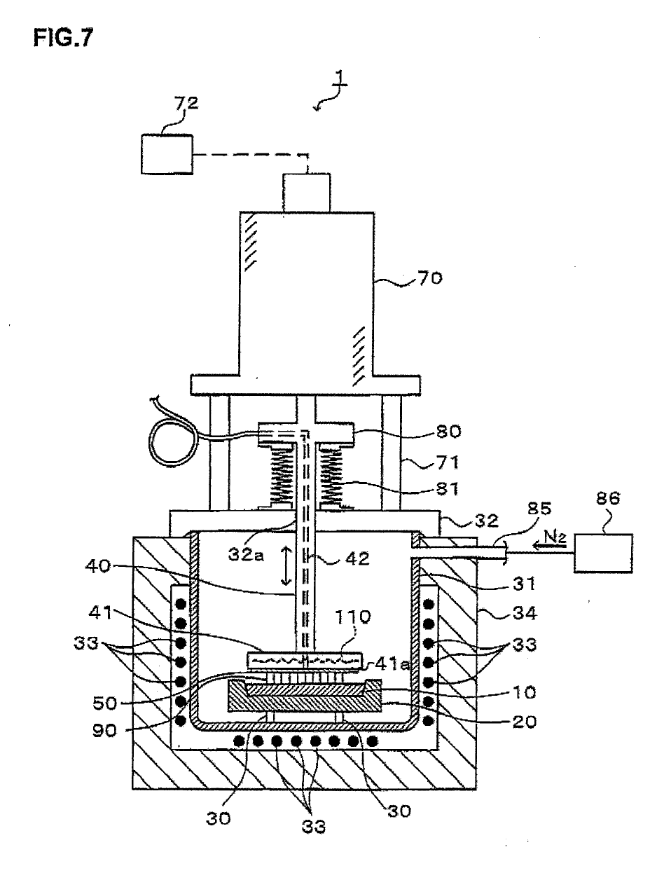

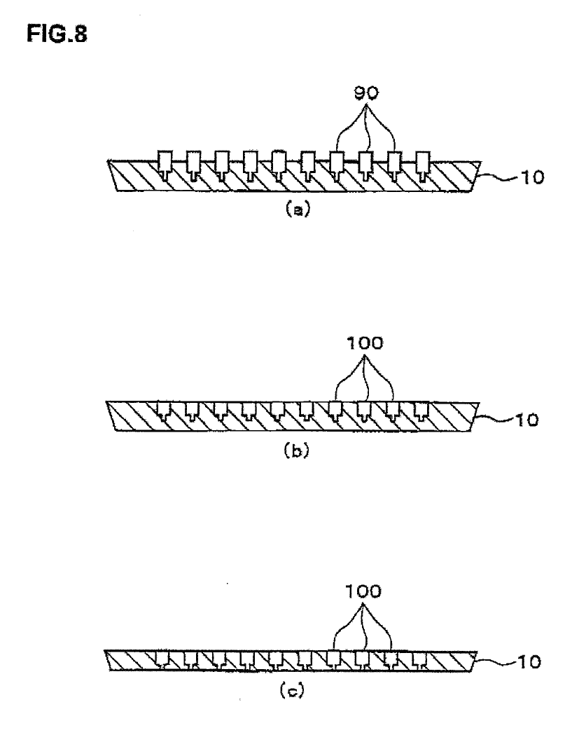

In the above-described embodiment, the hole forming pin 90 has a column shape, however, the shape thereof can be changed according to a required hole shape. For instance, as shown in FIG. 8, the shape of the hole forming pin 90 can be changed to have an approximately column shape with a step portion in which a lower portion becomes narrower than an upper portion. Also in this case, similar to the above embodiment, for instance, the hole forming pins 90 are Inserted into the melted glass substrate 10, and thereafter, the glass substrate 10 is solidified and taken out from the container 20 (FIG. 8(a)). After that, the hole forming pins 90 are dissolved in the aqua regia to be removed (FIG. 8(b)). Subsequently, the lower surface of the glass substrate 10 is polished to thereby form through holes 110 with step portions (FIG. 8(c)).

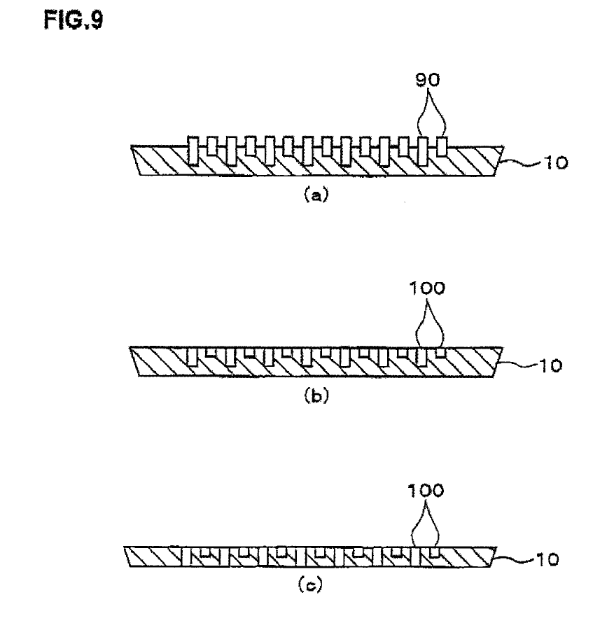

Further, the hole forming pins 90 having a different length and diameter may be mixed, as shown in FIG. 9. Also in this case, similar to the above embodiment, me hole forming pins 90 are inserted into the melted glass substrate 10, and thereafter, the glass substrate 10 is solidified and taken out from the container 20 (FIG. 9(a)). After that, the hole forming pins 90 are dissolved in the aqua regia to be removed (FIG. 9(b)). Subsequently, the lower surface of the glass substrate 10 is polished to thereby form holes 120 composed of through holes and bottomed holes (FIG. 9(c)).

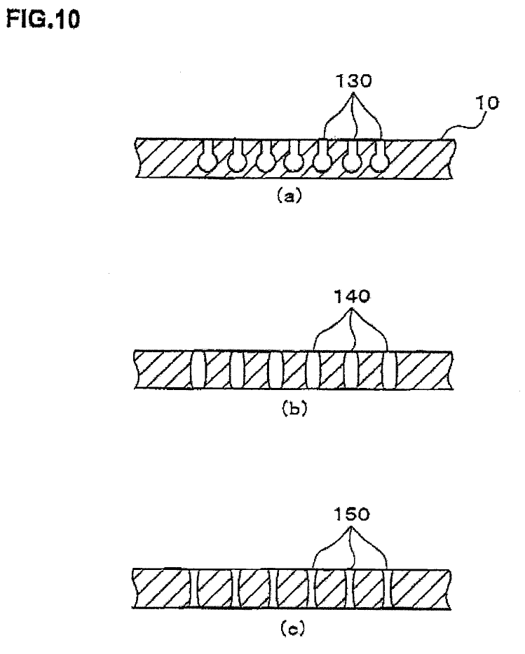

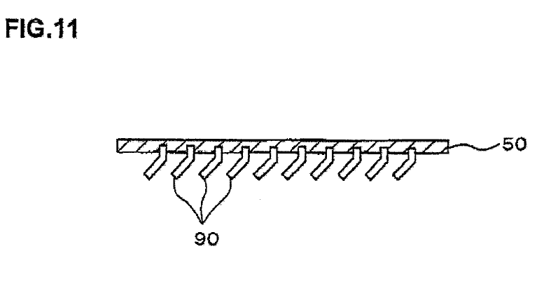

Further, as shown in FIG. 10, by varying the shape of the hole forming pins 90, it is possible to form holes such as holes 130 each having a spherical-shaped tip (FIG. 10(a)), holes 140 each having a wide central portion compared to upper end and lower end portions (FIG. 10(b)), and holes 150 each having a narrow central portion (FIG. 10(c)).

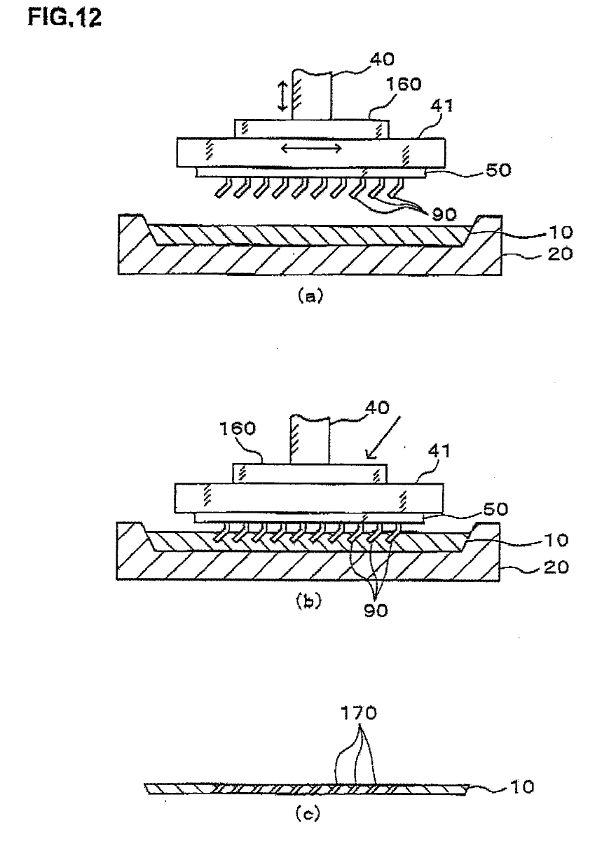

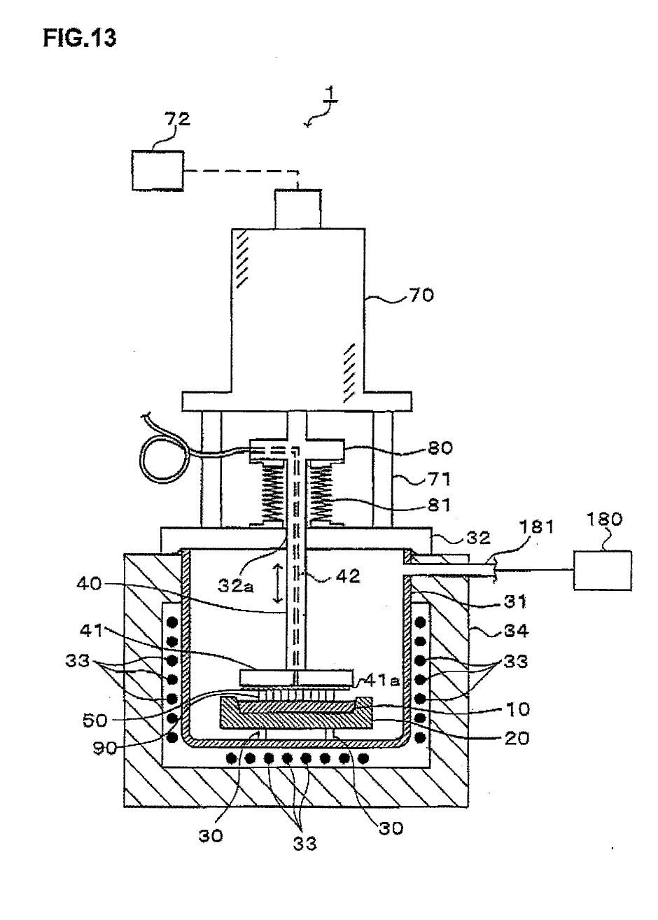

Further, angled holes may be formed in the glass substrate 10 by pointing the hole forming pins 90 diagonally with respect to the vertical direction, as shown in FIG. 11. In such a case, the hole forming apparatus 1 may be provided with a moving mechanism for moving the holding member 41 in a horizontal direction. For example, at a connecting portion between the shaft 40 and the holding member 41, a horizontal slide mechanism 160 is interposed, as shown in FIG. 12(a). In order to insert the hole forming pins 90 into the glass substrate 10, die holding member 41 is slid in the horizontal direction while being lowered, and the silicon substrate 50 is moved in the same direction as the angled direction of the hole forming pins 90, as shown in FIG. 12(b). By doing so, the hole forming pins 90 are inserted from rip portions thereof, diagonally into the glass substrate 10. Subsequently, after cooling the glass substrate 10, the hole forming pins 90 are dissolved in the aqua regia to thereby form angled holes 170 in the glass substrate 10, as shown in FIG. 12(c).

Although one example of the embodiment of the presort invention has been described, the present invention is not limited to this example but can take various forms. For example, the hole 100 described in the above embodiment may be a circular hole, a square hole having a rectangular parallelepiped shape, or a tapered-shaped hole. The shape of the glass substrate 10 described in the present embodiment is square, but it may adopt a variety of shapes such as circular. As for the silicon substrate 50 having the holes 50a formed thereon, a pin stand substrate made of carbon may be adopted instead. Further, the holes 50a of the silicon substrate 50 are bottomed holes, however, they may be through holes. Besides, when the glass substrate 10 is used as a substrate of a probe card for inspecting electric properties of an electronic circuit, it is further preferable that the glass substrate 10 is made of borosilicate glass. In this case, the thermal expansion coefficients of the glass substrate 10 where a large number of probe pins are attached thereto and a substrate of the electronic circuit become substantially the same, so that even when the temperature variation occurs at the inspection, the positional displacement between the probe pin and the electronic circuit is prevented, and thus a high positional accuracy of the probe pin can be assured.

The mechanism for maintaining the inside of the heating container 31 in a reduced oxygen atmosphere described in the above embodiment can be a pressure reducing mechanism. In such a case, the heating container 31 is provided with an exhaust pipe 181 communicating with the negative pressure generating device 180 placed outside of the heating container 31, as shown in FIG. 13. According to the example, the negative pressure generating device 180 and the exhaust pipe 181 compose the pressure reducing mechanism, for instance. When the glass substrate 10 is housed in the container 20 as described above, an atmosphere inside of the heating container 31 is exhausted through the exhaust pipe 181, and the pressure of the inside of the heating container 31 is reduced to be, for example, about 200 Pa. After that, the glass substrate 10 is melted as described above while the inside of the heating container 31 is maintained in a reduced pressure atmosphere, the hole forming pins 90 are inserted into the glass substrate 10, and the glass substrate 10 is then cooled to be solidified. When the glass substrate 10 is solidified, the reduced pressure of the inside of the heating container 31 is released and the glass substrate 10 is taken out from the heating container 31. Also in this case, since the inside of the heating container 31 is maintained in the reduced pressure atmosphere and the reduced oxygen atmosphere, an oxidation of the hole forming pins 90 and the Eke can be prevented. Note that, when the inside of the hearing container 31 is made to be reduced pressure atmosphere as the above example, a mechanical clamping method cam be adopted instead of the suction by the holding member 41, to fix the silicon substrate 50.

### INDUSTRIAL APPLICABILITY

The present invention is useful for forming a large number of fine holes in a glass substrate with high positional and dimensional accuracy.

What is claimed:

1. A method of forming holes in a glass substrate, comprising the steps of:
housing the glass substrate in a container having an opened upper surface;
forming a plurality of holes in a pin stand substrate and standing pins in the plurality of holes formed in the pin stand substrate;
placing the pin stand substrate opposite the glass substrate so that the pins of the pin stand substrate face a side of the glass substrate housed in the container;
heating and melting the glass substrate housed in the container;
approximating the pin stand substrate to the melted glass substrate and inserting the pins of the pin stand substrate into the glass substrate;
cooling and solidifying the glass substrate housed in the container while having the pins inserted therein;
taking out the glass substrate from the container; and
forming the holes in the glass substrate by removing the pins inserted therein.

2. The method of forming the holes hi the glass substrate according to claim 1,
wherein the plurality of holes are formed in the pin stand substrate by an etching.

3. The method of forming the holes in the glass substrate according to claim 1, further comprising
a step of penetrating the holes of the glass substrate by polishing a lower surface of the glass substrate after the pins are removed therefrom.

4. The method of forming the holes in the glass substrate according to claim 1,
wherein said step of inserting the pins into the glass substrate is performed by lowering the glass substrate in a predetermined speed using a raisable/lowerable holding member holding the glass substrate.

5. The method of forming the holes in the glass substrate according to claim 1,
wherein the pin stand substrate is also heated at said step of heating the glass substrate housed in the container.

6. The method of forming the holes in the glass substrate according to claim 1,
wherein the pin stand substrate is a silicon substrate.

7. The method of forming the holes in the glass substrate according to claim 1,
wherein the container is made of carbon.

8. The method of forming the holes m the glass substrate according to claim 1,
wherein the pin is made of a material possessing a heat resistance to a heating temperature of the glass substrate.

9. The method of forming the holes in the glass substrate according to claim 1,
wherein the pin is dissolved by liquid to be removed from the glass substrate.

10. The method of forming the holes in the glass substrate according to claim 9,
wherein the pin is made of metal and dissolved in an aqua regia.

11. The method of fanning the holes in the glass substrate according to claim 10,
wherein the pin is made of tungsten, stainless steel, molybdenum, nickel or nickel alloy.

12. The method of forming the holes in the glass substrate according to claim 1,
wherein at least said steps of melting the glass substrate, inserting the pins into the glass substrate, and solidifying the glass substrate are carried out in a reduced oxygen atmosphere.

13. The method of forming the holes in the glass substrate according to claim 12,
wherein the reduced oxygen atmosphere is a reduced pressure atmosphere.

14. A hole forming apparatus for forming holes in a glass substrate, comprising:
a container having an opened upper surface and capable of housing the glass substrate;
a heating container housing and heating said container;
a holding member holding a pin stand substrate having pins stood thereon above said container so that the pins face a side of the glass substrate housed in said container; and
a raising/lowering mechanism for inserting the pins of the pin stand substrate into the glass substrate housed in said container by raising/lowering said holding member.

15. The hole forming apparatus of the glass substrate according to claim 14,
wherein said holding member is provided with a heating member for heating the held pin stand substrate.

16. The hole forming apparatus of the glass substrate according to claim 14,
wherein said container is made of carbon.

17. The hole forming apparatus of the glass substrate according to claim 14, further comprising
a mechanism for maintaining the inside of said heating container in a reduced oxygen atmosphere.

18. The hole forming apparatus of the glass substrate according to claim 17,
wherein said mechanism for maintaining the reduced oxygen atmosphere is a pressure reducing mechanism.
